(19) United States
(12) Patent Application Publication
(10) Pub. No.: US 2023/0420962 A1
(43) Pub. Date: Dec. 28, 2023

(54) CHARGING CARD HOLDER

(71) Applicant: Shenzhen WETON Technology Co., Ltd., Shenzhen (CN)

(72) Inventor: Tongxing HUANG, Shenzhen (CN)

(21) Appl. No.: 18/461,301

(22) Filed: Sep. 5, 2023

(30) Foreign Application Priority Data
Jun. 27, 2023 (CN) 202321662771.8

(51) Int. Cl. H02J 7/00; H02J 50/10; H02J 50/90; H02J 7/34

(52) U.S. Cl. CPC H02J 7/0044; H02J 50/10; H02J 50/90; H02J 7/0063; H02J 7/342

(57) ABSTRACT

A small-volume charging holder includes a first wallet, a second wallet and a bendable portion which connects the first wallet with the second wallet so that the first wallet can be folded or unfolded relative to the second wallet. The second wallet is provided with at least one card slot for storing cards. The first wallet has a first surface, which is opposite to the second wallet when the first wallet is folded towards the second wallet. The first surface of the first wallet is provided with an energy storage power supply, which is configured to charge external devices.

### CROSS-REFERENCE TO RELATED APPLICATIONS

This application claims the benefit of priority from Chinese Patent Application No. 202321662771.8, filed on Jun. 27, 2023. The content of the aforementioned application, including any intervening amendments thereto, is incorporated herein by reference in its entirety.

### TECHNICAL FIELD

This application relates to the field of card holders, and more particularly to a charging card holder.

### BACKGROUND

Handheld wallets have been widely used in people's daily life, they can store cash and various cards, and have smaller size and better portability compared with backpacks or handbags.

However, the existing handheld wallets merely have the functions of holding cards and cash. As mobile devices (such as smartphones) become widespread, it is generally required to carry an additional mobile power for charging the mobile phone, and at the same time, they also need to carry wallets, which is inconvenient.

To solve the above problems, a card holder with charging function has been designed, which can also charge mobile phones in addition to storing identity cards and bank cards. For example, Chinese patent application No. 201510972910.0, discloses a multifunctional wallet. Unfortunately, for such existing multifunctional wallets, the power supply is generally built in a sandwich layer on one side of the card holder. One end of a charger cable is connected to the power supply, and the other end of the charger cable extends out of the sandwich layer. The arrangement of the power supply and the charger cable in the sandwich layer will render the card holder large in volume. Moreover, the capacity of the power supply is positively correlated with its volume. Therefore, it is urgent to optimize the volume of the card holder and improve the portability of the card holder to meet the consumers' needs.

### SUMMARY

In view of the problem that the traditional wallets have a single function, it's necessary to provide a small-volume charging card holder.

A charging card holder is provided, comprising:

a first wallet;

a second wallet; and

a bendable portion;

wherein the bendable portion is configured to connect the first wallet with the second wallet so that the first wallet is capable of being folded or unfolded relative to the second wallet; the second wallet is provided with at least one card slot which is configured to accommodate cards; the first wallet has a first surface, when the first wallet is folded towards the second wallet, the first surface is opposite to the second wallet; the first surface of the first wallet is provided with an energy storage power supply; and the energy storage power supply is configured to charge external devices.

In an embodiment, the first wallet is provided with a first mounting hole, and the energy storage power supply is provided with a second mounting hole corresponding to the first mounting hole; the charging card holder further includes a bolt; the bolt is configured to run through the first mounting hole to be fittingly connected with the second mounting hole so that the energy storage power supply is mounted on the first surface of the first wallet.

In an embodiment, the energy storage power supply includes a front panel, a rear panel, a battery and a charging assembly; the rear panel is configured to fit the front panel to form an accommodating cavity; the battery is arranged in the accommodating cavity; the charging assembly is electrically connected to the battery; the charging assembly includes a charging and discharging interface, a wireless charging coil or a combination thereof; and the second mounting hole is arranged on the front panel.

In an embodiment, the first surface of the first wallet is provided with a clamping slot, and the energy storage power supply is clamped in the clamping slot; or the first surface is adhesive, and the energy storage power supply is adhered to the first surface of the first wallet.

In an embodiment, a first magnet is provided in the first wallet, and the energy storage power supply is provided with a second magnet; and the first magnet and the second magnet are configured to attract each other so that the energy storage power supply is removably connected with the first surface.

In an embodiment, an area of the first surface is not greater than an area of the side of the energy storage power supply attached to the first surface.

In an embodiment, the charging card holder includes a charging data cable, and a side of the energy storage power supply is provided with a cable slot; one end of the charging data cable is electrically connected with the energy storage power supply in a non-removable manner, and the other end of the charging data cable is removably clamped in the cable slot; or both ends of the charging data cable are clamped in the cable slot.

In an embodiment, the bendable portion is fixedly provided with a fixing structure for fixing the charging data cable.

In an embodiment, the fixing structure is a Velcro strip, a binding strap or a magnetic component.

In an embodiment, a surface that the energy storage power supply is in contact with the first surface of the first wallet is the front panel; when the first wallet and the second wallet are folded together, a surface that the energy storage power supply is near the second wallet is the rear panel; a surface between the front panel and the rear panel is a side surface, and the side surface is provided with the charging and discharging interface which is configured to be electrically connected with the charging data cable.

The application has the following beneficial effects: the small volume charging card holder can also play a role as power source in addition to the wallet. In the existing charging wallets, the power source is generally built in a sandwich layer on one side of the card holder. One end of a charging cable is connected to the charging power source and the other end extends out of the sandwich layer. The arrangement of the power source and the charger cable in the sandwich layer will make the card holder larger than the power source in area, resulting in a larger overall volume. Moreover, due to the limitation of the battery technology, it is often required to increase the size of the power supply to reach a higher capacity, which will seriously affect the portability of the entire card holder.

Compared with the existing charging wallets, in the present disclosure, the energy storage power supply is arranged on the surface of the first wallet, such that the area of the card holder is not greater than the area of the energy storage power supply, allowing for reduced volume and higher portability. Meanwhile, the charging data cable can be arranged at the bendable portion, and the space formed when bending the bendable portion can be used to accommodate the charging data cable without occupying additional space, allowing for compact structure, small volume, and high portability.

### BRIEF DESCRIPTION OF THE DRAWINGS

FIG. 1 is a structural diagram of a small-volume charging card holder according to an embodiment of the present disclosure;

FIG. 2 is a structural diagram of the small-volume charging card holder according to an embodiment of the present disclosure; and

FIG. 3 is an exploded view of the small-volume charging card holder according to an embodiment of the present disclosure.

### DETAILED DESCRIPTION OF EMBODIMENTS

To make the above objectives, features and advantages of the present disclosure more obvious and understandable, the embodiments of the present disclosure will be described in detail below with reference to the accompanying drawings. Many specific details are set forth in the following description to facilitate a full understanding of the present disclosure. However, the present disclosure can be implemented in many other ways different from those description herein, and similar improvements can be made by those skilled in the art without departing from the spirit of the present disclosure. Therefore, the present disclosure is not limited to the specific embodiments described below.

It should be noted that, when an element is said to be “provided on” the other element, it may be directly on the other component or it can also exist intermediate components. When a component is considered to be “connected” to the other component, it can be directly or indirectly provided on another element. The terms, such as “vertical”, “horizontal”, “left”, and “right” are merely illustrative, and therefore are not intended to limit the disclosure.

Unless otherwise defined, all technical and scientific terms used herein have the same meaning as commonly understood by those skilled in the art. Terms used herein are merely for describing the specific embodiments and are not intend to limit the present disclosure.

This application provides a small-volume charging card holder, which can not only store cash and cards, but also charge external devices such as mobile phones.

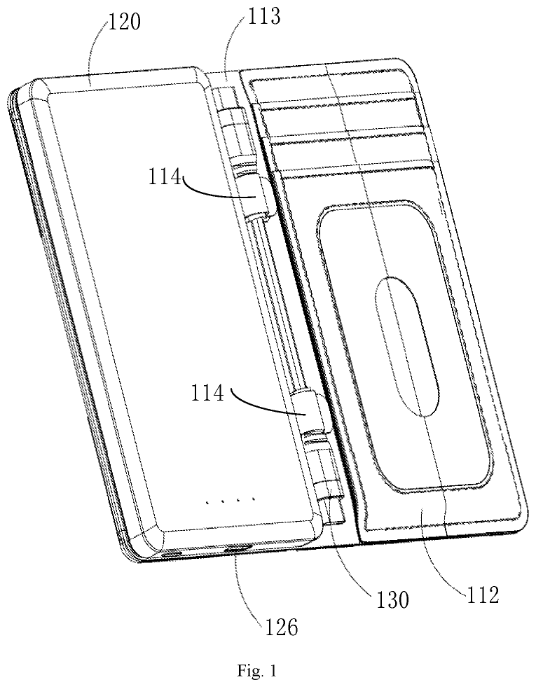

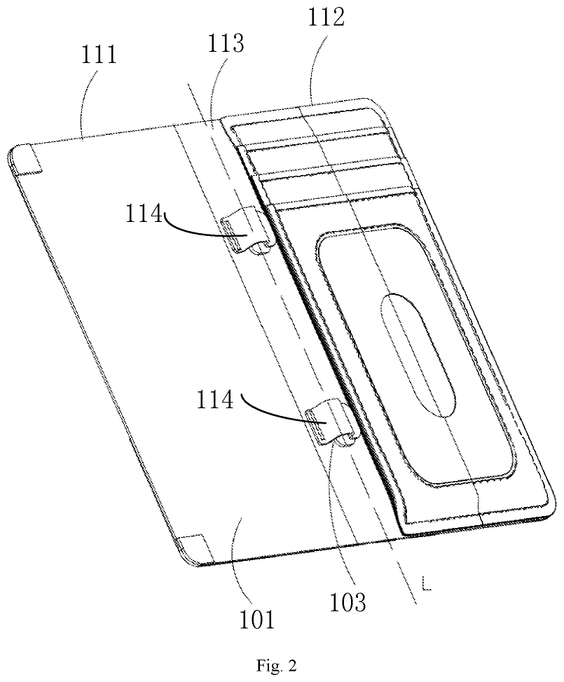

FIG. 1 is a schematic diagram of a charging card holder with an energy storage power supply 120, and FIG. 2 is a schematic diagram of the charging card holder without the energy storage power supply 120. The small-volume charging card holder includes a first wallet 111, a second wallet 112, and a bendable portion 113 for connecting the first wallet 111 with the second wallet 112. The first wallet 111 can be folded or unfolded relative to the second wallet 112. When not using the charging card holder, the first wallet can be folded towards the second wallet 112, so that the first wallet 111 covers the second wallet 112 to reduce the space occupation. The first wallet 111 can be unfolded relative to the second wallet 112 to take cash or cards. In this embodiment, surface materials of the first wallet 111 and the second wallet 112 can be leather or cloth.

Referring to FIG. 2, the second wallet 112 is provided with at least one card slot to at least accommodate cards, such as cards, business cards and cash. The first wallet 111 has a first surface 101, and when the first wallet 111 is folded towards the second wallet 112, the first surface 101 is relative to the second wallet 112. The first surface 101 is provided with an energy storage power supply 120 which is configured to store DC power and convert the stored DC energy so as to charge external devices.

The small-volume charging card holder provided in this embodiment can be used as a wallet and a mobile power to charge external devices such as mobile phones. Compared with the existing products, the power supply is generally built in a sandwich layer on one side of the card holder. One end of a charger cable is connected to a power supply, and the other end of the charger cable extends out of the sandwich layer. The arrangement of the power supply and the charger cable in the sandwich layer will render the card holder large in volume. Moreover, the capacity of the power supply is positively correlated with its volume, which seriously affects the portability of the whole card holder. In the present disclosure, the energy storage power supply is provided on the surface of the first wallet, such that the area of the card holder is not greater than the area of the energy storage power supply, allowing for reduced volume and higher portability.

In an embodiment, the first surface 101 of the first wallet 111 is provided with a clamping slot (absent in the figures) and the energy storage power supply 120 is clamped in the clamping slot. In this embodiment, the energy storage power supply 120 can be a cuboid with four corners. The clamping slot is provided with four positioning parts which can be mounted on the first surface 101 by means of bolts, adhesives and so on. A distance between the positioning parts and a distance between the four corners of the energy storage power supply 120 are the same, such that the four positioning parts can be respectively clamped at the four corners of the energy storage power supply 120 to fix the energy storage power supply 120 on the first surface 101. The structure of the clamping slot for clamping the energy storage power supply is similar to the structure of a phone shell for clamping a mobile phone.

In an embodiment, the first surface 101 is adhesive (not shown in the figures), and the energy storage power supply 120 is adhered to the first surface 101 of the first wallet 111. For example, the first surface 101 can be provided with a Velcro loop, and a surface of the energy storage power supply 120 in contact with the first surface 101 is provided with a Velcro hook. The Velcro loop and the Velcro hook are fastened mutually so that the energy storage power supply 120 can be removably mounted on the first surface 101.

In an embodiment, the first wallet 101 is provided with a first magnet (not shown in the figures) inside, and the energy storage power supply 120 is provided with a second magnet. The first magnet and the second magnet are configured to attract each other so that the energy storage power supply 120 can be removably attached to the first surface 101.

Although the above embodiments are not attached with figures, the text can be understood clearly by those skilled in the art. The above scheme can be implemented by those skilled in the art to achieve the expected effect.

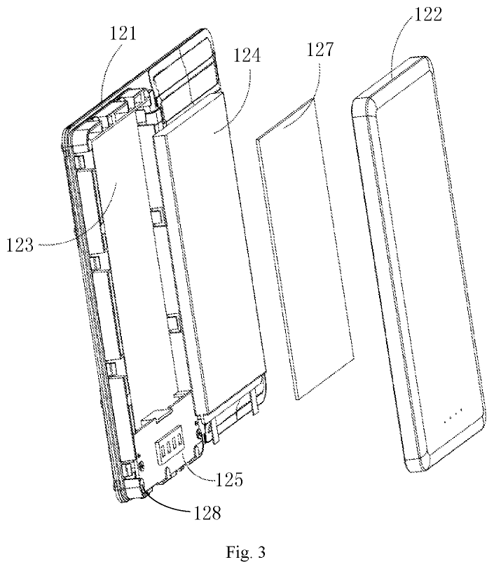

Referring to FIGS. 1-3, the first wallet 111 is provided with a first mounting hole, and the energy storage power supply 120 is provided with a second mounting hole 128 corresponding to the first mounting hole. A bolt runs through the first mounting hole to be fittingly connected to the second mounting hole 128, so as to mount the energy storage power supply 120 on the first surface 101. It can be understood that the number of the first mounting hole and the second mounting hole 128 and the distribution position of the first mounting hole on the first wallet 111 are not specifically limited herein as long as the combination of the first mounting hole, the second mounting hole 128 and the bolt can mount the energy storage power supply 120 on the first surface 101 of the first wallet 111.

In the above embodiment, since the energy storage power supply 120 is removably mounted on the card holder, users can also remove the energy storage power supply 120 for independent use. For example, the users can remove the energy storage power supply 120 and charge it separately if the energy storage power supply 120 is needed to be charged. When the storage power supply is charging, if the users go out and need to use the card holder, the users can still carry the card holder. In addition, the charging data cable 130 can be accommodated in the bendable portion 113 for convenience of users.

In an embodiment, the storage power supply 120 includes a front panel 121, a rear panel 122, a battery 124 and a charging assembly 125. The rear panel 122 is configured to fit the front panel 121 to form an accommodating cavity. The battery 124 is arranged in the accommodating cavity. The charging assembly 125 is electrically connected to the battery 124. The charging assembly 125 is configured to receive external AC or DC power supplies, and convert the AC or DC power to charge the battery 124. The charging assembly 124 can also convert the DC power stored in the battery 124 to charge external devices. The charging assembly 125 includes a charging and discharging interface, a wireless charging coil or a combination thereof.

In an embodiment, a surface of the energy storage power supply 120 in contact with the first surface 101 of the first wallet is the front panel 121. When the first wallet 111 and the second wallet 112 are folded, a surface of the energy storage power supply 120 near the second wallet 112 is the rear panel 122, a surface between the front panel 121 and the rear panel 122 is a side surface. The second mounting hole 128 of the above embodiment is provided on the front panel 121.

The front panel 121 and the rear panel 122 of the energy storage power supply can be made of metal materials, such as stainless steel, aluminum alloy, zinc alloy or other metal materials, or plastic materials, such as ABS (Acrylonitrile Butadiene Styrene), PC (Polycarbonate), TPU (Thermoplastic Polyurethane) and so on, or other materials, such as ceramic, wood, leather, carbon fiber and so on. The materials of the front panel 121 and the rear panel 122 can be the same or different.

The battery 124 and the charging assembly 125 are arranged along the lengthwise direction of the front panel 121 and the rear panel 122 so as to reduce the thickness of the energy storage power supply. In this embodiment, the charging assembly 125 can include both the charging and discharging interface 126 and the wireless charging coil. The charging and discharging interface 126 is provided on the side surface, and the wireless charging coil can be provided between the battery 124 and the rear panel 122 so that the users can wirelessly charge by attaching external devices to the surface of the back panel 122.

In an embodiment, the energy storage power supply 120 further includes an insulating material layer 127 between the battery 124 and the rear panel 122. The insulating material layer 127 is configured to insulate the battery 124 from outside to prevent electricity leakage of the battery 124. The insulating material layer 127 can be an insulating paper, such as fish paper.

In an embodiment, an area of the first surface 101 is not greater than an area of the surface that the energy storage power supply fits the first surface 101. Preferably, the area of the first surface 101 is equal to the area of the surface that the storage power supply fits the first surface 101. Referring to FIGS. 1-2, a boundary of the first surface 101 is flush with a boundary of the energy storage power supply 120. Further, a size of the first wallet can be adapted to a size of the storage power supply 120, which can reduce the volume of the charging card holder. It is particularly noted that, the area of the first surface 101 is not greater than the area of the surface that the energy storage power supply 120 fits the first surface 101, which should include the case that owing to the process limitation, the area of the first surface 101 is slightly greater than the area of the surface that the storage power supply 120 fits the first surface 101.

In an embodiment, the small-volume charging card holder includes a charging data cable 130, which is configured to be connected to the charging and discharging interface of the energy storage power supply 120, so that the energy storage power supply 120 can charge the external devices through the charging data cable 130. Alternatively, the energy storage power supply 120 can be connected to an external power supply through the charging data cable 130 so that the external power supply can charge the battery 124 of the energy storage power supply 120 through the charging data cable 130. The side surface 120 is provided with a cable slot. One end of the charging data cable 130 and the energy storage power supply 120 are electrically connected irremovably, and the other end of the charging data cable is removably mounted in the cable slot. Or both ends of the charging data cable are mounted in the cable slot removably, which the charging data cable 130 and the energy storage power supply 120 are removably connected and the charging data cable 130 can be accommodated in the cable slot after removed.

In an embodiment, the bendable portion 113 is provided with a fixing structure of the charging data cable 114 to accommodate at least part of the charging data cable 130 in the bendable portion 113. By accommodating the charging data cable 130 in the bendable portion 113, it will not take up extra space of the card bag no matter the card holder is folded or unfolded, which makes the structure of the card bag is more compact and reduces the volume of the card holder.

The fixing structure 114 can be a Velcro strip, a binding strap or a magnetic component. In some embodiments, the bendable portion 113 can be provided with a through hole 103 extending along the bending axis-L, which is configured to accommodate the charging data cable 130. The through hole 103 can be formed by sewing or pasting on the bendable portion 113, or it can be formed by grooving the surface of the bendable portion 113. The number of the through hole 103 can be one or more. Multiple through holes 103 can be coaxially arranged along the bending axis-L so that the multiple through holes can be used jointly to accommodate the charging data cable 130.

In an embodiment, the bendable portion 113 can be provided with a binding tape, and the charging data cable 130 is bound by the binding tape. For example, the binding tape can be an elastic band, a Velcro strip and so on, and the binding tape can be sewn or pasted to the surface of the bendable portion 113.

This application is to provide a small-volume charging card holder, which can be used as a wallet and charge external devices such as mobile phones. Besides, the energy storage power supply 120 is provided on the surface of the first wallet for reduced volume and high portability. By setting the charging data cable 130 in the bendable portion 113, the space formed by the bendable portion can be used to accommodate the charging data cable without taking up extra space, which makes the card bag in compact structure and small size, and easy to carry and use.

The technical features of the above embodiments can be combined. For the sake of concise and simplified description, not all possible combinations of the technical features of the above embodiments have been described. However, as long as there is no contradiction in the combination of these technical features, such combination should be considered to fall within the scope of this application.

Described above are only several embodiments of the disclosure, and the description is relatively specific and detailed. However, it cannot be understood as a limitation of the scope of the disclosure. It should be noted that, those of ordinary skill in the art can make several variations and improvements without departing from the spirit of the disclosure, which shall also fall within the scope of the disclosure defined by the appended claims.

What is claimed is:

1. A charging card holder, comprising:
a first wallet;
a second wallet; and
a bendable portion;
wherein the bendable portion is configured to connect the first wallet with the second wallet so that the first wallet is capable of being folded or unfolded relative to the second wallet; the second wallet is provided with at least one card slot which is configured to accommodate cards; the first wallet has a first surface; when the first wallet is folded towards the second wallet, the first surface is opposite to the second wallet; the first surface of the first wallet is provided with an energy storage power supply; and the energy storage power supply is configured to charge an external device.

2. The charging card holder of claim 1, wherein the first wallet is provided with a first mounting hole, and the energy storage power supply is provided with a second mounting hole corresponding to the first mounting hole; and
the charging card holder further comprises a bolt; the bolt is configured to run through the first mounting hole to be fittingly connected with the second mounting hole so that the energy storage power supply is mounted on the first surface of the first wallet.

3. The charging card holder of claim 2, wherein the energy storage power supply comprises a front panel, a rear panel, a battery and a charging assembly; the rear panel is configured to fit the front panel to form an accommodating cavity; the battery is arranged in the accommodating cavity; the charging assembly is electrically connected to the battery; the charging assembly comprises a charging and discharging interface, a wireless charging coil or a combination thereof; and the second mounting hole is arranged on the front panel.

4. The charging card holder of claim 1, wherein a first magnet is provided in the first wallet, and the energy storage power supply is provided with a second magnet; and the first magnet and the second magnet are configured to attract each other so that the energy storage power supply is removably connected with the first surface.

5. The charging card holder of claim 4, wherein the energy storage power supply comprises an insulating material layer arranged between the battery and the rear panel.

6. The charging card holder of claim 1, wherein the first surface of the first wallet is provided with a clamping slot, and the energy storage power supply is clamped in the clamping slot; or
the first surface is adhesive, and the energy storage power supply is adhered to the first surface of the first wallet.

7. The charging card holder of claim 1, wherein an area of the first surface is not greater than an area of a side of the energy storage power supply attached to the first surface.

8. The charging card holder of claim 1, further comprising:
a charging data cable;
wherein the charging data cable is configured to electrically connect the energy storage power supply with the external device; and
a side of the energy storage power supply is provided with a cable slot; one end of the charging data cable is electrically connected with the energy storage power supply in a non-removable manner, and the other end of the charging data cable is removably clamped in the cable slot; or
both ends of the charging data cable are removably clamped in the cable slot.

9. The charging card holder of claim 8, wherein the bendable portion is fixedly provided with a fixing structure for fixing the charging data cable.

10. The charging card holder of claim 9, wherein the fixing structure is a Velcro strip, a binding strap or a magnetic component.
